(19) United States
(12) Patent Application Publication
(10) Pub. No.: US 2009/0261293 A1
(43) Pub. Date: Oct. 22, 2009

(54) Method of producing the pulp based food carton that emit FIR

(76) Inventor: Duck Hoon Kim, San Francisco, CA (US)

Correspondence Address: Young Kim, 1844 Balboa Street, San Francisco, CA, 94121, US

(21) Appl. No.: 12/106,299

(22) Filed: Apr. 20, 2008

(51) Int. Cl. C09K 3/00; B02C 23/08; B02C 23/20

(52) U.S. Cl. 252/182.32; 241/25

(57) ABSTRACT

This invention relates pulp based food carton and a method thereof, said carton is formed of pulp material with the incorporation of Optimum Resonant (different types of mineral elements) that naturally emit far infrared radiation (FIR), allowing the foods to be kept fresher and longer with better taste to provide benefits to both consumers and the farmers. Cartons use in storing, packaging, protecting of eggs, milk and beverage are disclosed.

### FIELD OF SEARCH

264/241: 206/521:424/650

### REFERENCE

1. Theory and Practice for Heating of FIR by Far Infrared Rays committee of Japan
2. Sunlight, Zane Kime, M. D., Pengrove, Calif., World Health Publications, 1980 Articles on Light Therapy, pg 261
3. Bulletin of the School of Agriculture, Meiji University title: Effects of Far-infrared ray (FIR) irradiation on reproduction, growth, behavior and some physiological parameter by NAGASAWA H (Meiji Univ.) KOIKE T (Meiji Univ.) UDAGAWA Y (Meiji Univ.)

### DESCRIPTION OF INVENTION

### BRIEF SUMMARY

This invention regards the producing and manufacturing processes of pulp based food cartons that emit far infrared radiation, made from incorporating Optimum Resonant (mixture of many different varieties of minerals elements) and pulp, allowing the food products such as eggs and milk to be kept fresh. More descriptively, this invention deals with the production and manufacturing processes of food cartons that involve using the Bio-powder made up of the powdered bio-stone and clay minerals(naturally chelated, trace minerals) fused with pulp, forming it into container products, which will emit far infrared radiation, keeping and extending the freshness of the foods.

### BACKGROUND

Various cartons made of pulp are being used to store and distribute foods, but as eggs and milk products that are sensitive to temperature and must be kept fresh; it has been kept at the temperature under 45 degrees Fahrenheit. But regardless of all these efforts, freshness of the food especially eggs and milk is hard to maintain and the shelf life is under 30 days. Incorporating different types of mineral elements that emit far infrared radiation in the pulp that the egg and milk cartons are made of, eggs and milks will be kept fresher for a longer period of time with better taste, providing benefits to both consumers as well as the farmers.

Technical Issues the Invention is Aimed at Achieving:

The purpose/goal of this invention is aimed at producing and manufacturing the pulp based food carton that help extend the freshness of the foods, gets rid of foul odors. This pulp base food carton will emit high amounts of far infrared radiation as it is made of mixed substances that emit such radiation.

Invention's Composition and Function:

Bio Stone is comprised of silicon dioxide (SiO), and aluminum oxide etc., making it possible to emit far infrared radiation, and the efficiency is excellent—with 92-93% radiation. Having electrical characteristics, the positive pole absorbs the negative ions and the negative pole discharges negative ions, producing continuous electric current of 0.06 mA and instantaneously releasing it in the air. As a natural source of far infrared ray, it is known as a mineral that helps to relieve stress, improve blood circulation as well as immunity. This bio stone is known to accelerate the metabolization of animals and vegetables, and help deodorize scents, prevent bacterial growth, soften hard water, relieve pain, purify water and air, improve strength and health, normalize blood cholesterol, prevent mold, maintain body warmth and better sleep, enhance and maintain freshness of foods, and accelerate the alkalization of the food fluids by the emission of FIR. General formula of Bio-stone can be written as : XY₃Z₆(T₆O₁₈)(BO₃)₃V₃W

Clay Mineral is naturally chelated, trace minerals made of volcanic ashes accumulated at the bottom of lakes, it is formed of all natural 78 mineral elements and it's basic structure is MgO Al₂ O₂.SiO₂ nH₂O.

| | |
|---|---|
| Aluminum | Al |
| Antimony | Sb |
| Arsenic | As |
| Barium | Ba |
| Beryllium | Be |
| Bismuth | Bi |
| Boron | B |
| Bromine | Br |
| Cadmium | Cd |
| Calcium | Ca |
| Carbon | C |
| Cerium | Ce |
| Cesium | Cs |
| Chlorine | Cl |
| Chromium | Cr |
| Cobalt | Co |
| Copper | Cu |
| Dysprosium | Dy |
| Erbium | Er |
| Europium | Eu |
| Fluorine | F |
| Gadolinium | Gd |
| Gallium | Ga |
| Germanium | Ge |
| Gold | Au |
| Hafnium | Hf |
| Holmium | Ho |
| Hydrogen | H |
| Indium | In |
| Iodine | I |
| Iridium | Ir |
| Iron | Fe |
| Lanthanum | La |
| Lead | Pb |
| Lithium | Li |
| Lutetium | Lu |
| Manganese | Mn |
| Magnesium | Mg |
| Mercury | Hg |
| Molybdenum | Mo |
| Neodymium | Nd |
| Nickel | Ni |
| Niobium | Nb |
| Nitrogen | N |
| Osmium | Os |
| Oxygen | O |
| Palladium | Pd |
| Phosphorus | P |
| Platinum | Pt |
| Potassium | K |
| Praseodymium | Pr |
| Rhenium | Re |
| Rhodium | Rh |
| Rubidium | Rb |
| Ruthenium | Ru |
| Samarium | Sm |
| Scandium | Sc |
| Selenium | Se |
| Silicon | Si |
| Silver | Ag |
| Sodium | Na |
| Strontium | Sr |
| Sulphur | S |
| Tantalum | Ta |
| Tellurium | Te |
| Terbium | Tb |
| Thallium | Tl |
| Thorium | Th |
| Thulium | Tm |
| Tin | Sn |
| Titanium | Ti |
| Tungsten | W |
| Uranium | U |
| Vanadium | V |
| Ytterbium | Yb |
| Yttrium | Y |
| Zinc | Zn |
| Zirconium | Zr |

This clay mineral also like the bio stone, emit FIR (far infrared ray) and does not have any hazardous components but absorb hazardous substances in bodies, and has the effects of medical treatments and tranquilizers. Due to the enzyme's catalysis it helps with metabolization, muscle functions, cell creations, restoration of cells, and growth. These mineral elements provide biological benefits in live cells, and are essential to all living lives' growth, whether plants or animals.

By incorporating these essential mineral elements in food cartons along with the bio stone, it will help with food carton and cell functions, extending the time of food keeping and freshness.

This invention involves using the maximum benefits of the FIR (far infrared ray) emitted by the bio stone and clay minerals by mixing the right ratio of mineral powders into pulp, forming and drying it into food carton, which would then enhance and maintain the freshness, as well as prevent bacterial growth, and extend the shelve life of the eggs and milks.

### DETAILED DESCRIPTION

The processing method of this food cartons is:
1. Bio-powder: Preparing the bio-stone and clay minerals in 200˜500 meshes.
2. pulping step: mixing water to raw pulp materials and mixing the bio-powder, thus creating pulp blend
3. Molding step: taking the pulp blend from step 2 and molding it into food carton.
4. drying and finishing: drying the molded food carton from step 3 and perfecting them as products

The preparation for the bio-powder is grinding the bio-stone and the clay minerals in the weight ratio of 20-30% to the total weight of the bio-stone (100%) into 200˜500 mesh.

Pulping step is mixing the raw pulp materials and the bio-powder into the fixed ratio, and adding water and other binders for them to blend well and make it glutinous.

The main materials consist of the mixture of pulp (85-99% weight) and the bio-powder (1-15% weight), and the bio-powder consists of the mixture of 200˜500 mesh of powdered bio-stone and the clay mineral. The greater the ratio of the bio-powder is to pulp, the greater the far infrared radiation emitted from the containers would be; but if the ratio of the bio-powder exceeds 15% of the total weight, the unique resilient characteristics of the pulp will be lost, making the finished container products to be prone to getting easily crushed due to shock, but this problem can be complemented by gluey binders, i.e. resin etc.

The bio-powder mix used in this invention has high emissivity of far infrared ray, producing great results even with small amounts, which means that only 1˜5% weight of the bio-powder can be added to 95˜99% weight of the pulp and still achieve great results.

The additives involved will contribute unique characteristics and/or complement the uniqueness of the property of the materials used. These additives will consist of variety of ingredients, including disinfecting, binding, waterproofing materials, as well as coloring and neutralizing agents if needed, and will be used in the ratio of 0˜6% weight to the total 100% weight of the pulp and bio-powder mix.

The molding step is taking the well blended pulp, bio-powder and additive mix, and putting it in a fixed mold and making it into necessary food container shape. Generally, the above molding step consists of having a fixed mold in the shape of necessary food containers and letting the pulp, bio-powder, additive mix to stick to the mold surfaces, then be removed to be dried.

Drying and finishing step: The formed materials from the molding step will be removed to dry, and then be perfected as a marketable product.

In the drying step, there are methods of using the heat, or using the hot wind to achieve the effects necessary (eliminating all moisture), and can be done by going through the drying process once, or even two or more times using the same drying method each time, or by fusing different methods.

The food cartons that are made from this process, will have small amounts of the bio-powder evenly distributed, maintaining the pulp's unique resiliency as well as the elasticity and emit far infrared radiation as well, keeping the egg and milk fresh and suppress bacterial penetrations, thus preventing contaminations such as salmonella etc., while minimizing bad odors coming from the foods.

These food cartons emit far infrared radiation, helping the food including egg to be kept in optimum condition, to be alkalized, for the freshness to be enhanced and maintained, prevent bacterial growth, minimize bad odors, extend the shelf life of the milk and eggs, providing benefits to both consumers as well as the farmers. Also, the manufacturing process is simple and the commercial use will be easy, benefiting both manufacturers as well as the consumers.

1. The preparation for the bio-powder is grinding the bio-stone and the clay minerals into 200˜500 mesh.

2. Pulping step is mixing the raw pulp materials and the bio-powder into the fixed ratio, and adding water and other binders for them to blend well and make it glutinous.

3. The main materials consist of the mixture of pulp (85-99% weight) and the bio-powder (1-15% weight).

4. The bio-powder consists of the mixture of 200˜500 mesh of powdered bio-stone and the clay mineral that naturally chelated trace mineral complex
